(19) United States
(12) Patent Application Publication
(10) Pub. No.: US 2003/0139967 A1
(43) Pub. Date: Jul. 24, 2003

(54) Automated management service system

(76) Inventor: Steve Carleton, Farmington Hills, MI (US)

Correspondence Address: Amy E. Rinaldo, Kohn & Associates, Suite 410, 30500 Northwestern Highway, Farmington Hills, MI, 48334, US

(21) Appl. No.: 10/055,240

(22) Filed: Jan. 23, 2002

(51) Int. Cl. G06F 17/60

(52) U.S. Cl. 705/16; 705/8

(57) ABSTRACT

There is provided the automated management service system having a securing device for securing an item necessary for performing a service, a service station for providing the service, and a communication device for communicating information between the securing device and the service station such that the communication device includes a processor for processing and selectively communicating the information. Also provided is a method for managing a service facility by securing an item necessary for a service and communicating to the service facility that the item is secured and communicating only the information necessary for performing the service.

### BACKGROUND OF THE INVENTION

1. TECHNICAL FIELD

The present invention relates to an automated management service system. More specifically, the present invention relates to a system for remotely controlling a service facility.

2. BACKGROUND ART

Having routine maintenance done on an automobile has become more and more inconvenient. Neighborhood gas stations no longer pump gas for individuals, let alone provide any sort of maintenance. Facilities that do provide routine maintenance on automobiles have therefore become more widely dispersed, causing inconvenience to automobile owners by requiring them to travel further to these facilities.

Additionally, the hours of operation of routine maintenance facilities are generally coincident with the working hours of a vast number of individuals. This adds to the inconvenience of obtaining routine maintenance. Those individuals not fortunate enough to rotate or otherwise adjust their working hours are forced to converge on automobile servicing facilities at the same time, namely lunch hours, directly before and after work hours, and on weekends. This causes a high demand for routine maintenance service at the same periods of time, causing an additional inconvenience for automobile owners.

To alleviate the inconvenience of traveling to distant automobile servicing facilities at inconvenient times, mobile automotive servicing facilities have been proposed. The general idea behind such facilities is to provide a servicing facility that may travel to parking lots used by individuals during working hours, such as at large factories, office buildings, installations or shopping areas or other large public facilities where the automobile normally spends a great deal of time being idle. Example mobile servicing facilities are disclosed in U.S. Pat. No. 4,981,318 to Doane et al. and U.S. Pat. No. 3,308,845 to Bellas et al.

The Doane et al. patent discloses a mobile service facility including a frame, having a floor, a forward end, a rearward end, and spaced sides extending between the ends. A roof overlies the floor. An entrance for an automobile is provided at the forward end of the apparatus. Corner post assemblies are positioned adjacent the forward end of the frame and on one side of the frame for maintaining the roof space above the floor. Each corner post assembly is movable between a closed position for travel and an open position in which the forward end is widened so that a vehicle wider than the spaced sides of the frame may be driven onto the floor without interference from the corner post assemblies. The spaced side walls disclosed in the Doane et al. patent are extendable so that a vehicle wider than the spaced sides in the closed configuration may be driven onto the floor.

The Bellas et al. patent discloses a mobile automotive servicing facility having a van body portion consisting of side wall portions, a front wall portion, a back portion, and top wall portion. An entrance is provided at the back portion of the van body for ingress and egress by an automobile. A lift is provided to receive the automobile entering through the rear entrance. Extendable top portions and side portions of the van body may be pivoted to extend the top and width of the van body for servicing the automobile.

The Doane et al., Bellas et al. and other prior art mobile servicing facilities have several shortcomings that have limited their acceptance and use. For example, these prior facilities have failed to adequately accommodate a sufficient number of vehicles in a timely manner due to space limitations. Space limitations also prevent service technicians from having convenient and adequate access to the vehicle and deprive customers of the normal amenities associated with automobile servicing, such as a waiting room and restroom facilities. These prior facilities have also been lacking in safety features. Additionally, prior mobile servicing facilities have failed to provide an environment with suitable protection from inclement weather, including extreme cold, heat, snow, rain, etc.

An additional limitation of the prior art service facility is that there is no disclosure in the prior art for the general concept of an automated management system for controlling the service facility. The service facility can be for vehicle service or for other services. The concepts in the prior art have been limited to a mobile service station and have not touched upon the concept of automating the service such that individuals do not have to leave the comforts of their office space in order to have services performed.

It would therefore be useful to develop a management system for service stations such that an individual can obtain service of their vehicle or other item without interfering with their work schedule. It would also be useful to develop a remote management system for remotely controlling a service station.

### SUMMARY OF THE INVENTION

According to the present invention, there is provided the automated management service system having a securing device for securing an item necessary for performing a service, a service station for providing the service, and a communication device for communicating information between the securing device and the service station such that the communication device includes a processor for processing and selectively communicating the information. Also provided is a method for managing a service facility by securing an item necessary for a service and communicating to the service facility that the item is secured and communicating only the information necessary for performing the service.

### DESCRIPTION OF THE DRAWINGS

Other advantages of the present invention are readily appreciated as the same becomes better understood by reference to the following detailed description when considered in connection with the accompanying drawings wherein:

FIG. 1 is a side view of the mobile service station of the present invention;

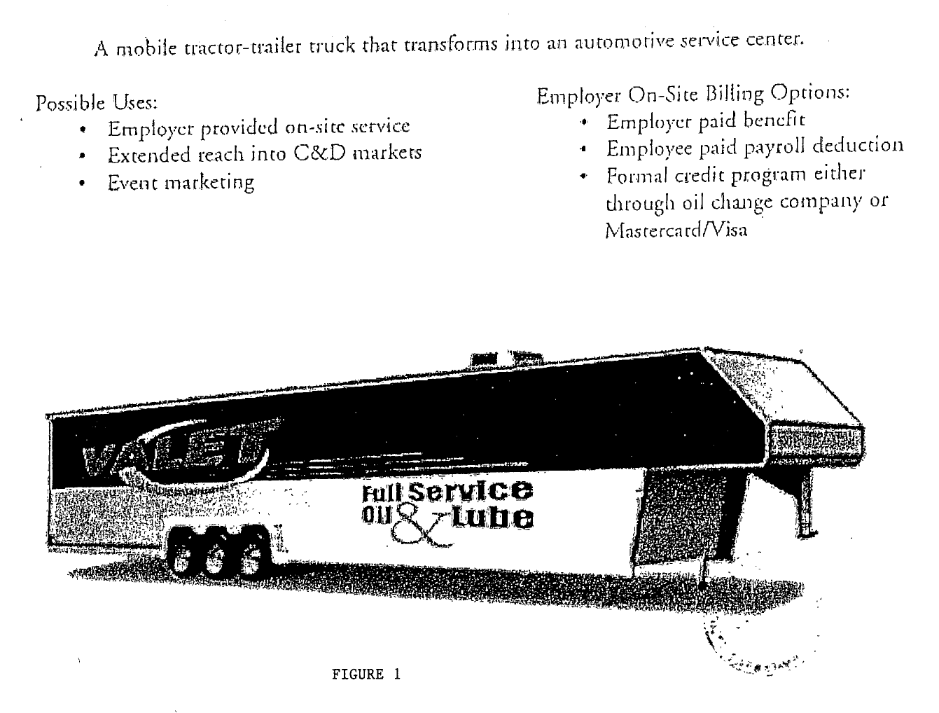

FIG. 2 is a side view of the interior of the mobile service station of the present invention;

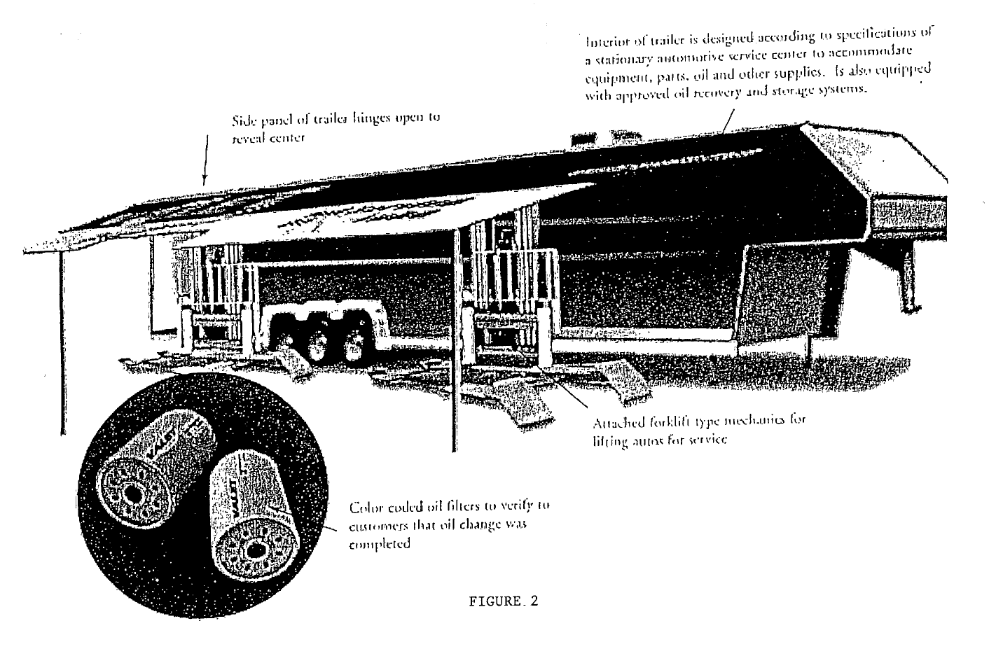

FIG. 3 is a side view of an alternative embodiment of the mobile service station of the present invention;

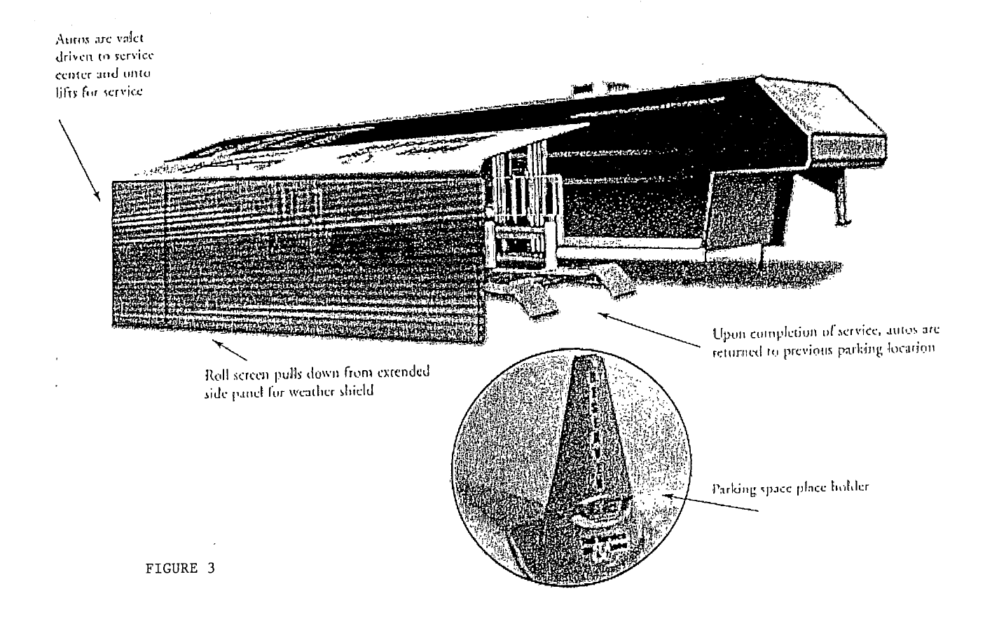

FIG. 4 is a view of the lock box and an extended view of the key system of the present invention;

FIG. 5 is an alternative embodiment of the lock box of the present invention;

FIG. 6 is a view of the token machine and tracking system of the present invention;

FIG. 7 is an informational flow chart depicting how information travels through the management system of the present invention; and

FIG. 8 is a detailed flow diagram of the service system of the present invention.

### DETAILED DESCRIPTION OF THE INVENTION

Generally, the present invention provides an automated management service system. This system includes a securing device for securing an item necessary for performing a service, a service station for providing the service, and a communicator device for communicating information between the securing device and the service station. Preferably, the communicating device includes a processor for processing and selectively communicating the information.

By the term “services” it is meant to include, but is not limited to, any services which can be accomplished by service technicians such as housecleaning service, automotive services and lawn care services. For example the automotive services can include, but are not limited to, services such as oil changes, lube service, brake service, tune-ups, tire rotation and other similar services. This list is not meant to be exhaustive and is merely included to provide examples of services with which the station of the present invention can be associated. The services can be performed at a location remote from any management and/or housed business. For example, it can be performed on an automobile in the customer's parking lot.

By “automated” it is meant that a computer system, or any other automated system, is installed to control immediate and virtual management of the services. The system is controlled by virtual or non-virtual management which is not involved in the daily service activities, but instead monitors activities and maintains the financial records of the service stations. Management bills the individuals in charge of payment for all services, either directly or as a benefit package.

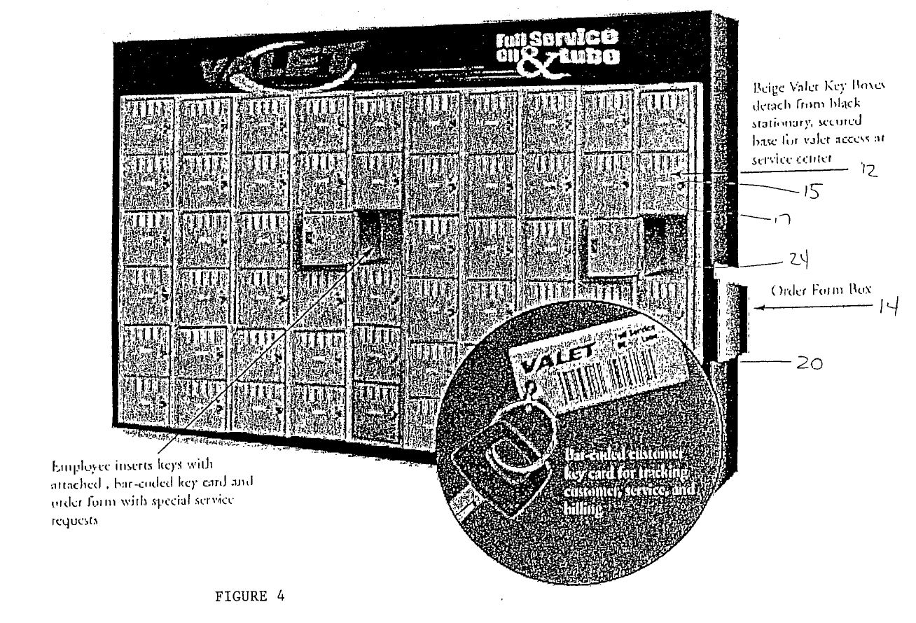

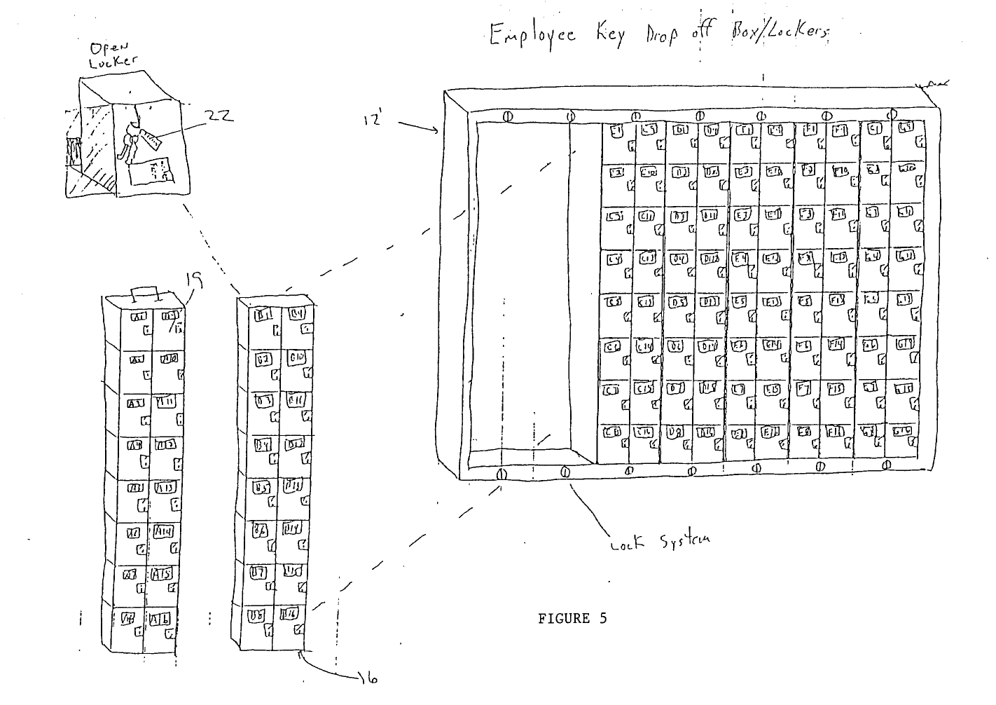

The “securing device” is a device which is capable of securely retaining the item placed therein. This can include, for example, a drop box 12 such as those shown in FIG. 4 and 5 and described in detail below. For example, the drop box 12 can be a single group of boxes as shown in FIG. 4, wherein the boxes 12 are opened individually and the boxes 12 are all maintained as a unit. Alternatively, the boxes 12 can be removable as shown in FIG. 5. The removable group of boxes is shown as 16 in the Figure. The group can be removed without the loss of security and when the group is in place the group is locked such that the group cannot be removed without an access object such as a key. This allows the service individual to remove a group of boxes 12 without preventing others from dropping off items 22.

If the service being provided is automotive service, the secured device functions as follows. The drop box 12 is designed such that the individual receiving the services leaves their vehicle keys 22 (or other item) without the concern of the keys 22 being stolen. This is accomplished by using locking boxes 12, as shown in FIGS. 4 and 5. The individual can utilize the key boxes as shown in FIGS. 4 and 5 by placing the keys in an open box 24 and when closing the box 12 a key 15 or other access device 15 can be removed such that the individual can come back at a later time and retrieve their keys 22 without enabling another individual, without such an access device 15, an opportunity to obtain the keys 22.

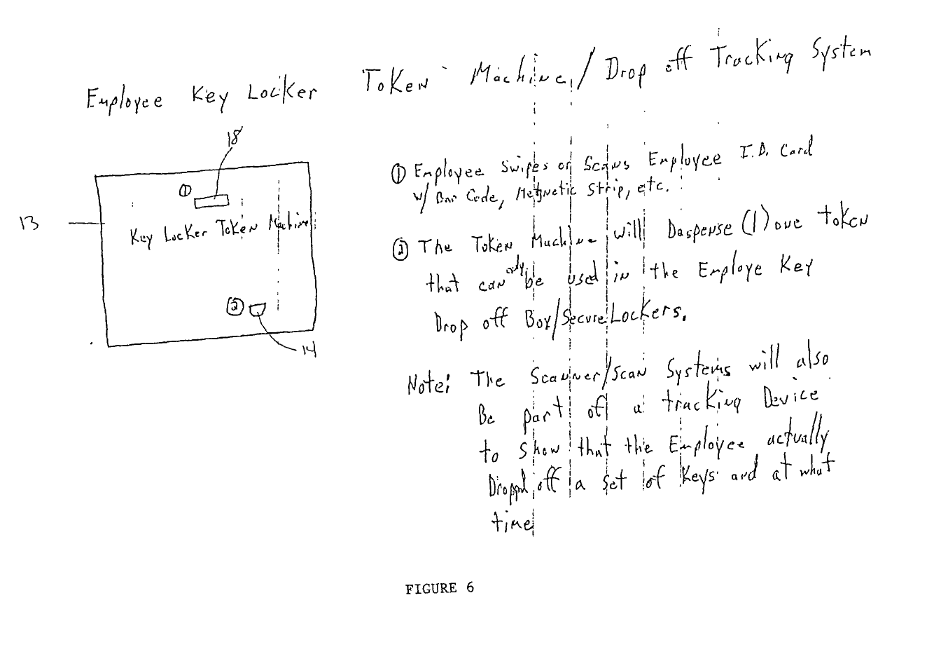

In an alternative embodiment, shown in FIG. 6, the individual can obtain a token 14 from a token machine 13 which is attached to the securing device. The token 14 can be obtained when either the individual pays for such a token, or the individual uses an identification card through a swiping device 18 which grants the individual access to the tokens 14. The token 14 is then placed into a slot 19 on the front of a drop box 12 and a key 15, or other similar device 15′, located on the front of the drop box 12 is able to be turned and removed from the drop box 12. The drop box 12 then opens enabling the individual to place the key 22 or other identifying item within the drop box 12. The individual then shuts the door 19 to the drop box 12 thus securing the item within the drop box 12 with only two people having access to the drop box 12, first the individual having the key 15 and second the individual who can later perform service utilizing the item within the drop box 12. The individual then returns later in the day and retrieves the item 22 by placing the key 15 in the drop box 12 where the individual left the item 22 earlier in the day. After the drop box 12 is opened, the key 15 is retained by the drop box 12 for use by another individual.

The securing device can also include a scanning/swiping device 18 which is affixed to the drop area such that access to the drop area 12 is contingent upon the device 18 reading an appropriate ID card which serves as a gatekeeper. The scanning device 18 can read an ID card given to the individual which grants access to the vehicle keys 22 to the owner of the vehicle and also establishes that the vehicle was dropped off for service. Alternatively, the ID card can also contain therein information pertaining to the individual and what services they can receive or need to have done, the make and model of the individual's vehicle, and other pertinent information relating to the individual. This information is not available to the people manning the service station, but can be made available to anybody who controls the system.

The swiping mechanism 18 functions as follows. The slot 18 where the credit card is swiped has the capability of accepting either a normal type of credit card or other similar card to be used in conjunction with the system. The customer would swipe their card prior to depositing the item necessary for the service.

Lights indicate the validity of the card. If the card is swiped and is then not accepted a red light is activated. However, if the card is accepted, a green light is activated.

The screen shows the options available. It also indicates on the screen “swipe card now” so the individual knows when to use their card. A receipt is discharged from the receipt port so the individual can take it for their records. The display screen shows the information such as the services available. As stated above, the lights show if the card is accepted or not. If the red light flashes, it means that the card is declined and a buzzer sounds. If the green light flashes, it means that the card is good and a bell sounds. A speaker can emit sounds of a buzzer, and bell, and other sounds.

The swipe box is preferably a mounted electronic credit card swipe mechanism that allows the individual to swipe their credit card, or other similar card, without having to hand the card to the anyone else. In operation, the individual presses the button that displays the desired service.

Power for the device is preferably derived from a battery, although any power source can be utilized. The device is interconnected with the rest of the system and the output is transmitted to a debit card swipe system. The individual “depresses” the appropriate service push-button. The individual runs their card through the slot in the card swipe system. The analog cellular telephone system, or other communication system as disclosed above, makes contact with the credit agency and the magnetic strip information and cost is forwarded and to debit the card. At this point, one of two actions can occur; either the debit is accepted and the “green” light is illuminated and the bell sounds, or the debit is rejected and the “red” light is illuminated and the buzzer sounds. Some delay in receiving card charge approval or rejection can be expected. The delay can be of the same duration as those at stores when card charges are made.

Variations of the system employ a cellular communications system with satellite uplink capability to insure that there is no interruption in communication by cellular company zoning and blackout areas. Another variation could incorporate a global positioning system (GPS) unit where coordinates and location could be displayed with a map that can be viewed by the driver. Still another variation could accept only a universal debit card, similar to a telephone debit card. This eliminates the need for the analog cellular communications equipment and increase the speed of the transaction. Also, a variation could be provided that utilizes microwave communications to finalize the transaction.

Alternatively, the swiping device can function as a credit card machine. In this embodiment of the invention the credit card machine functions to allow the person to swipe their credit card through the machine such that it the service can be billed directly to the individuals credit card. In this embodiment the information from the individual travels via a communicating device to a processor for determining if the individual has a credit limit sufficient to pay for the service to be performed. If the processor determines that there insufficient credit then the processor can send back to the to the securing means a message that the individual cannot gain access to the securing device and therefore the individual cannot have the service performed at that time.

The swiping can also function as an authorization for payroll deduction in much the same way as it functions with the credit card machine. In other words, as with credit card application, the individual swipes an identification card or bar code card through the machine and enters a pin number or other access code number thereby granting or permitting a payroll deduction for this service.

The scanning device can also use a prepaid card such that an individual can put so much money on the card at the beginning of the year or can receive a card from their employer with a certain amount of money on the card for such services. By swiping the card through the scanner or swiping device and entering a pin number or other authorization code the individual is authorizing a deduction in the amount of money on that card to be taken for the service to be performed. In this embodiment, the scanning device is in communication with processing device and the processing device can determine if there is sufficient funds on the prepaid card to authorize the service to be desired. This is determined using the screen disclosed above, or other screen.

Additionally, the prepaid card could be part of a dealer or lease package, such that when an individual either buys or leases a car as part of the package they would receive a prepaid card good for so many different services, i.e. oil changes, in a year. This, in conjunction with the management system, enables the dealership to monitor the maintenance records for a vehicle over a period of time.

Finally, the card utilized can be a benefit card which functions similar to that of a credit card or the prepaid card such that the swiping or scanning device is in communication with a processor and the processor determines if the individual is authorized to have such a benefit at this time. If the individual is not authorized to have such a benefit they are denied access to the securing device.

In conjunction with the scanning/swiping device, a screen with either a touch pad screen or a key pad can be attached thereto. On the screen there is disclosed a list of services that are offered. This enables the individual to determine what services they would like performed and authorize payment for these services prior to the services actually being conducted. Alternatively, the individual can fill out a form which would be in a box affixed to the securing device. The form would be filled out manually and placed in the box with the item necessary for performing the services. For example, with a vehicle service station the ATM screen could have several options including oil, lube, filter, and transmission check, brake fluid check, rotation of tires, etc. Additionally on this form there is an indication of where the vehicle is located in the parking lot. This can either be done using a map or having the individual park select locations and indicating the number of the location where the vehicle is on the form or on the ATM screen.

The swiping device can include an interactive display system, is provided in which a touch-sensitive screen, or white board, is used as a projection surface. Control signals are generated by the touch-sensitive screen in the usual manner responsive to user applied pressure (e.g. due to drawing on the board with a marker, pointer, stylus or finger, etc.). At the same time, a computer can be used to execute any one or more well known applications programs, in the usual manner. However, according to the present invention, the computer generated screen is projected onto the touch-sensitive screen utilizing an LCD projector panel in conjunction with an overhead projector. Control signals received from the touch-sensitive screen are integrated with the computer generated graphics so as to be projected therewith onto the touch-sensitive screen. In this way, a completely interactive display system is provided in which the user can highlight and edit information generated by the computer program by simply drawing on the touch-sensitive screen.

Multiple interactive computer projection systems can be interconnected (i.e. networked) and supported by a voice conferencing system such that any of several groups of users can view the output displays or input information to the system at the same time (i.e. the information is communicated to and updates all on-line computers and display devices).

Therefore, there is provided an interactive display system, as follows:

a) one or more touch-sensitive display surfaces for detecting predetermined events associated therewith and in response generating control signals for identifying the events and indicating locations thereof,

b) one or more computers for selectively executing one or more applications programs and in response generating screen video displays, the one or more computers being connected to respective ones of the touch-sensitive display surfaces,

c) a driver device in each the one or more computers for receiving the control signals from an associated one of the touch-sensitive display surfaces and in response generating a command to a selected one of the applications programs for identifying an associated one of the computers and for identifying the events and indicating the locations thereof, whereby the selected applications program executes the command and updates the screen video displays in accordance therewith, and

d) a projector connected to the one or more computers for receiving and projecting the screen video displays onto the one or more touch-sensitive display surfaces.

There is also provided an interactive display system, including the following:

a) a touch-sensitive display screen for sensing pressure applied thereto and in response generating control signals indicating locations of the applied pressure, and

b) a receiver for receiving the control signals and in response generating and projecting graphic images onto the touch sensitive display screen at the locations.

By “communicating device” as disclosed herein, it is intended to mean fax lines, phone lines, modem, TI line, Internet, DSL, cable modem, dial-up Internet, wide area network, Intranet, local area network, ISDN, wireless connections, satellite communications, direct cable connection, radio communication, and audio communication. The communicating device of the present invention preferably includes a processor for processing and selectively communicating information. This processor includes a gate-keeping device which selectively communicates information from one location to another. For example, only the information pertaining to service can be disclosed to the individuals manning the service station. The individuals manning the service station does not receive access to billing, personal, or account information. The gatekeeping function can also include an access device. The access device is held by the billing individuals and the service individuals and provides them with access to the relevant information. The access device can include, but is not limited to, a PIN number or other access code.

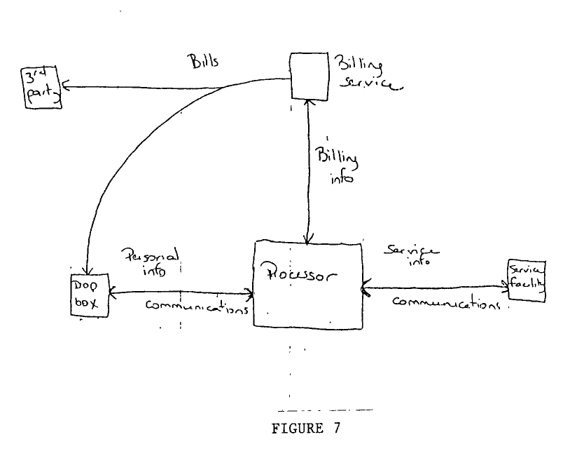

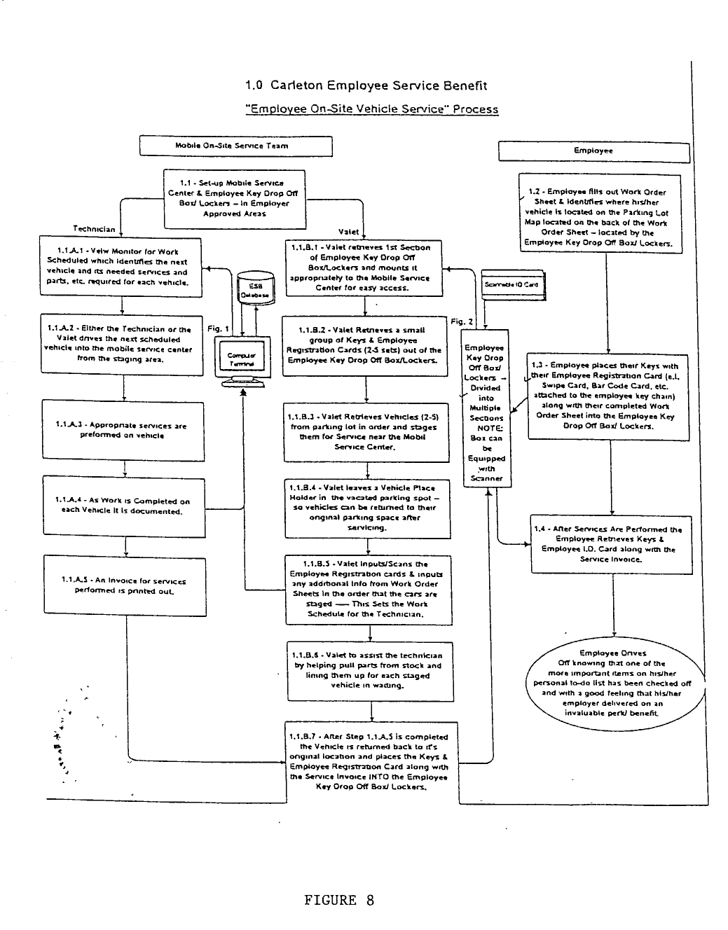

The “processor” of the present invention is preferably a computer, computer program, or other device or individual which can differentiate between types of information and selectively distribute the information according to guidelines set forth herein. For example, only billing information is sent to the billing service and only the information necessary for service is sent to the service station. Alternatively, the processor can be an individual who manually provides the information either through inputting or through telephonic conversations to either the service station or billing service. In the preferred embodiment, the processor is software which controls the flow of information between the service station and the securing device as shown in FIGS. 7 and 8.

Generally, the system functions as shown in FIGS. 7 and 8 and discussed in detail below. The individual customer either drops off their keys with a form requesting certain service or the individual scans their ID card and the system can inform the people manning the station of the services to be conducted. Then, an individual manning the station retrieves the vehicle and checks the information storage device to determine what services need to be conducted. “Information Storage Device” is intended to mean, but is not limited to, an electronic storage (i.e. disk, tape, RAID system, etc.) database. When the service is complete, the individual manning the station documents that the service is complete by entering this information into the information storage device and the vehicle can be returned to its previous location. Finally, an invoice is created and sent to the party responsible for paying for the services.

More specifically, the system of the present invention functions as follows when used in association with a vehicle service station. The keys have been dropped into the securing device an individual from the service station retrieves the keys from the lock box. This can be accomplished by either unlocking the entire system of boxes, unlocking each box individually, or taking out sections of the box as shown in FIG. 5. When the key has been removed from the box a tracking system can be placed on the key or other item to insure that the key or other item is returned to the proper box and, in the instance of vehicle servicing, that the car is returned to the proper parking location. The tracking system is also placed on a cone which is placed in the parking spot of the vehicle. This tracking system can be a bar coding, a paper notation, or another tracking device which provides sufficient tracking to insure that the key or other item is returned to the proper box location and that the car can also be returned to its proper location.

Once the keys have been obtained, the employee of the service station retrieves the information regarding the service to be conducted on that vehicle. In the instance of a vehicle service center, the vehicle is retrieved from its parking spot and brought to a mobile service station or other service station for servicing. The service is then provided for either the vehicle or other item in need of service. The employee can then enter any additional information regarding the vehicle or item to be serviced into the communication system and then prepare the car to be serviced. This information includes the fact that service has been performed. Once the service has been conducted and the information is communicated throughout the processor, the vehicle or other item is returned to its proper location and the key or other item is returned to the box which can then be retrieved by the individual who put the key or other item in the lock box. Optionally, an invoice can be generated by the service station which can be given to the individual. For example, an invoice can be placed in the vehicle or in the drop box 12.

An additional aspect of the present invention is the availability of billing services. A billing service can be in communication with the processor. The billing service receives information strictly related to the billing services, no other information is provided for the billing service. For example, the only information which would be required would be the information pertaining to who would pay the bill and how much each service cost. The billing would then be sent to the individual in charge of paying for the service(s).

In one embodiment of the present invention, the billing is sent to a benefits department of a corporation where the services are offered as benefits to employees of the corporation. This can exist on three potential levels. First, the benefit can strictly be the on site access to such a service. Second, the service can be provided as a payroll deduction program. In this level, the services can be deducted from an individual's paycheck on a regular basis, for instance monthly, quarterly, etc. or the services can be deducted on a as needed basis. In other words, the payroll deduction could either be taken automatically, whether or not the services are utilized, or could only take place once a service has been performed. The third option is that the services are paid for by the employer. The employer can either pay for all services or a portion of the services provided. For example, when the employer pays for a portion of the services, a certain amount of money could be paid for by the employer and anything above and beyond that would be paid for by the employee.

When the service is being provided as part of a benefits package, the employees participating the in benefits package must register with the management service company. The employees could register in three specific manners: (1) web based registration, (2) paper registration, or (3) electronic registration. The registration allows the employees to input information regarding themselves and any relatives who are eligible for the benefits. In the web based registration, individuals could update their existing registration profiles as needed. In the other forms of registration individuals have to contact an employee at the management system to update their profile. When inputting this information, it is necessary to validate the imported data to insure that it meets with the guidelines of the system. The data is validated as follows. First, the system is edited against predefined specifications defined by the system. For example, the specification can include a database containing specific details regarding vehicles such as type of oil, filter, etc. Any data that falls outside the predefined specification levels is recorded and inspected separately to determine what sort of modification would be necessary to place the registration in compliance. The individual can then be contacted to determine if the modification should be made in order to put them in compliance. Finally, once all of these steps are complete the information is considered validated.

The present invention also provides a mobile service vehicle that contains therein a vehicle service center, thus the interior of the service center is designed according to specifications of a stationary service center. This includes, but is not limited to, various grades of oil, windshield wiper fluid, transmission fluid, and other such items as are found in a stationary vehicle center. Also included are oil drainage systems and oil retention devices, as are required in order to comply with federal regulations.

The service station can be located at any desired location. For example, in the parking lot of a large company, in an adjacent lot of a large corporation or it can be periodically moved between various locations of a corporation. Upon selecting a location for the station the station can open for service.

The station can have side panels, as shown in the attached figures, which open to reveal the interior of the station. These panels can also serve as protection from the elements, because in the preferred embodiment of the present invention the panels lift up to reveal the interior. Upon lifting, the panels are held in place with supports. The supports can be poles or other similar support structures which have sufficient strength to support the panel. Further, the panel can also have the capability of having further sections attached thereto (weather shields), thus providing further protection from the elements. This capability enables the service center to be open year round. Additionally, the station can have both heat and air conditioning provided within the main area of the station.

In the preferred embodiment, vehicles enter the station as shown in the attached figures. However, the vehicles can also enter the rear of the actual station, without having to open the side panels of the station. Further, the vehicles can enter in any other manner, as long as the vehicle is able to get both into and out of the station without causing damage.

Additionally, the present invention can include lift mechanisms for lifting automobiles in need of service. This lift mechanism can include, but is not limited to, a forklift or any other lift systems capable of lifting a vehicle.

Another aspect of the present invention includes the use of colored oil filters or other automotive parts. This enables the patron to be ensured that work has been done on the vehicle. The colored part is therefore placed on the vehicle and when a part is changed the color of the part is changed, thus providing a verification for the patron that the service has been performed.

In another embodiment of the present invention, the service station provides valet service for patrons. This functions by providing a central drop location where patrons leave their car keys along with a form indicating the type of service required. This drop location is secure so that the vehicle keys cannot be stolen subsequent to placement in the drop location. An example of this location is depicted in the attached figures. However, other drop location embodiments can be utilized without departing from the spirit of the present invention.

An attendant at the service station periodically checks the drop location for keys. Upon receipt of the keys, the attendant retrieves the vehicle in need of service and drives the vehicle to the location of the service center. When the vehicle is removed from the parking spot, a parking spot retention device is used to maintain the individual's parking spot. This retention device can be a cone, a large log shaped object, or other object which can easily be placed in a parking spot for maintaining the patron's parking spot.

Payment of these services can occur in any number of ways. These include, but are not limited to, bar coded customer key cards linked to a formal credit card, credit program through the company owning the service center, as an employer paid benefit, or an employee paid payroll deduction. For the latter examples, this can be achieved through an agreement between the employer and the service station provider or through other systems as are known to those of skill in the art.

The benefits of the present invention include that these services can be extended to individuals in both C and D markets. These markets are too small to maintain these type of services on their own. Therefore, by providing a mobile service station, these services can be provided for smaller markets, since one station can provide service for multiple locations.

Additionally, as set forth above, these centers can be used to provide employer-provided on-site service. With the advent of numerous employer benefits and the tight job market, companies are attempting to offer to their employees various services. This station enables the employer to provide another much needed service without interfering with the flow of work.

The station of the present invention can be used for event marketing. In other words, the station can be set up at various events and provide this service to individuals who are at the event. Finally, the station can be set up in conjunction with valet parking. For example, the station can be set up at shopping malls which provide valet service, restaurants that provide valet service or other such establishments which have similar services provided.

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

What is claimed is:

1. An automated management service system comprising:
securing means for securing an item necessary for performing a service;
a service station for providing the service; and
communication means for communicating information between said securing means and said service station said service communication means including processing means for processing and selectively communicating the information.

2. The system according to claim 1, wherein said securing means is a drop-off box.

3. The system according to claim 1, wherein said securing mean includes technology selected from the group consisting essentially of scan technology and swipe technology for gaining entry into said securing means.

4. The system according to claim 3, wherein said securing means further includes token dispensing and token accepting means for dispensing and accepting tokens, said tokens limiting access to said securing means.

5. The system according to claim 1, wherein said communication means is selected from the group consisting essentially of fax lines, phone lines, modem, TI line, Internet, DSL, cable modem, dial-up Internet, wide area network, Intranet, local area network, ISDN, wireless connections, satellite communications, direct cable connection, radio communication, and audio communication.

6. The system according to claim 1, wherein said processing means is a gate-keeping device for selectively communicating information, whereby said gate-keeping device only communicates service information to said service station.

7. The system according to claim 1, wherein said service station is a mobile vehicle service station.

8. The system according to claim 1, further including billing means for billing for the service, said billing means in communication with said communication means.

9. The system according to claim 8, wherein said processing means is a gate-keeping device for selectively communicating the information, whereby said gate-keeping device only communicates billing information to said billing means.

10. The system according to claim 3, wherein said swipe technology includes a swipe card and card reader.

11. The system according to claim 10, wherein said swipe card is selected from the group consisting essentially of an identification card, prepaid card, credit card, and benefit card.

12. The system according to claim 1, further including color-coded parts for indicating service has occurred.

13. The system according to claim 1, further including a tracking system.

14. A method for managing a service facility by:
securing an item necessary for a service;
communicating to the service facility that the item is secured and communicating only information necessary for performing the service.

15. The method according to claim 12, wherein said method includes communicating to a billing service only information necessary for billing the service.

16. The method according to claim 12, wherein said communicating step includes processing the information received.

17. A service station for use with the system according to claim 1, said service station comprising a station with removable sides, placement cones for placement at the location of the vehicle, and a variety of service parts.
